(19) United States
(12) Patent Application Publication
(10) Pub. No.: US 2007/0278853 A1
(43) Pub. Date: Dec. 6, 2007

(54) Motorcycle Brake System

(75) Inventors: Ronald Bayer, Muhlheim/Main (DE); Peter Rieth, Eltville (DE); Johann Jungbecker, Badenheim (DE); Georg Roll, Heusenstamm (DE)

Correspondence Address: CONTINENTAL TEVES, INC., ONE CONTINENTAL DRIVE, AUBURN HILLLS, MI, 48326-1581, US

(73) Assignee: CONTINENTAL TEVES AG & CO. OHG

(21) Appl. No.: 10/588,666

(22) PCT Filed: Jan. 7, 2005
(86) PCT No.: PCT/EP05/50052

§ 371 Date: Jun. 19, 2007

(30) Foreign Application Priority Data
Feb. 6, 2004 (DE) 10 2004 006 108.4
Sep. 28, 2004 (DE) 10 2004 046 940.7

(51) Int. Cl. B60T 13/00

(52) U.S. Cl. 303/9.64

(57) ABSTRACT

Disclosed is a motorcycle brake system in which, during brake slip control, the pressure buildup in the front-wheel brake circuit (2) is determined depending on the switching position of the inlet and outlet valves (21, 22) by the brake fluid volume which is available in the master brake cylinder (7) and can be displaced exclusively manually into the front-wheel brake circuit (2); and the brake fluid volume provided in the master brake cylinder (7) is monitored in order to prevent exhaustion of the brake fluid volume.

### BACKGROUND OF THE INVENTION

The present invention relates to a motorcycle brake system with at least one hydraulically operable front-wheel brake circuit, with a manually operable master brake cylinder that is connected to the front-wheel brake circuit and in communication with a brake fluid supply tank, with at least one inlet valve and outlet valve that can be activated for brake slip control in the front-wheel brake circuit, characterized in that in a brake slip control operation, the pressure buildup in the front-wheel brake circuit (2) is determined, depending on the switching position of the inlet and outlet valves (21, 22), by the brake fluid volume which is available in the master brake cylinder (7) and displaceable exclusively manually into the front-wheel brake circuit (2), and the brake fluid volume prevailing in the master brake cylinder (7) is monitored to prevent exhaustion of the brake fluid volume.

EP 1 176 075 A2 discloses a motorcycle brake system of this type. This brake system has a complex structure and is hence expensive because it operates according to the return principle. Therefore, brake systems of this type are not employed in low-cost motorcycles so that usually the brake system in motorcycles of the lower price segment is not equipped with brake slip control.

In view of the above, there is the general risk in motorcycles of the lower price segment that the front wheel tends to lock on bad, in particular, wet roads and when a brake operation is initiated abruptly. In the worst case, the front wheel will lock, and the cornering force will thus be lost. Especially as regards motorcycles, insufficient driving stability causes an extremely critical condition and represents a great risk potential for the driver in view of the danger of falling.

In view of the above, an object of the invention is to develop a low-cost, functionally reliable brake system with brake slip control which is especially well suited for the application in motorcycles of the low and medium price level.

### SUMMARY OF THE INVENTION

This object is achieved for a motorcycle brake system including a brake slip control operation, the pressure buildup in the front-wheel brake circuit (2) is determined, depending on the switching position of the inlet and outlet valves (21, 22), by the brake fluid volume which is available in the master brake cylinder (7) and displaceable exclusively manually into the front-wheel brake circuit (2), and the brake fluid volume prevailing in the master brake cylinder (7) is monitored to prevent exhaustion of the brake fluid volume.

Further features and advantages of the invention can be seen in the subsequent description of an embodiment by way of two drawings.

### BRIEF DESCRIPTION OF THE DRAWINGS

In the drawings:

FIG. 1 is a schematic view of the arrangement of the motorcycle brake system of the invention for controlling the brake slip at the front-wheel brake of a motorcycle;

FIG. 2 is the design of a favorable front-wheel brake unit for the motorcycle brake system of FIG. 1 in a schematically illustrated connection to the front-wheel brake.

### DETAILED DESCRIPTION OF THE DRAWINGS

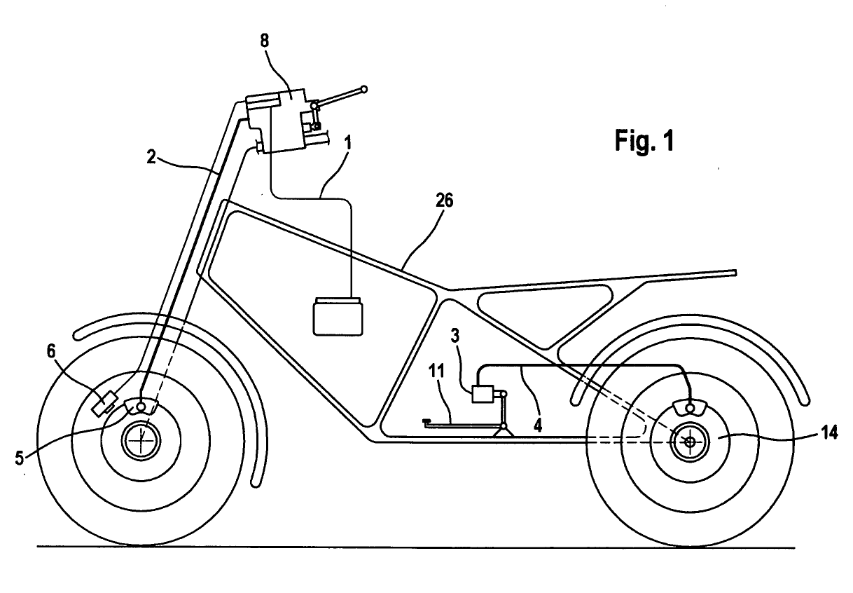

FIG. 1 shows a schematic side view of a motorcycle, the front wheel of which is equipped with a hydraulically operable wheel brake 5 and a wheel rotational speed sensor 6. A so-called front-wheel brake unit 8 being an essential component of the motorcycle brake system is mounted at the steering rod 9, said unit being connected to the brake caliper of the wheel brake 5 by way of the illustrated brake line 20 of the front-wheel brake circuit 2. The front-wheel brake unit 8 connects to the electrical wiring system 1 of the motorcycle for the supply with electric energy.

Further, FIG. 1 illustrates a conventional hydraulic rear-wheel brake circuit 4, comprising a master brake cylinder 3, which can be operated proportionally to pedal force and connects to a disc brake by way of the brake line of the rear-wheel brake circuit 4.

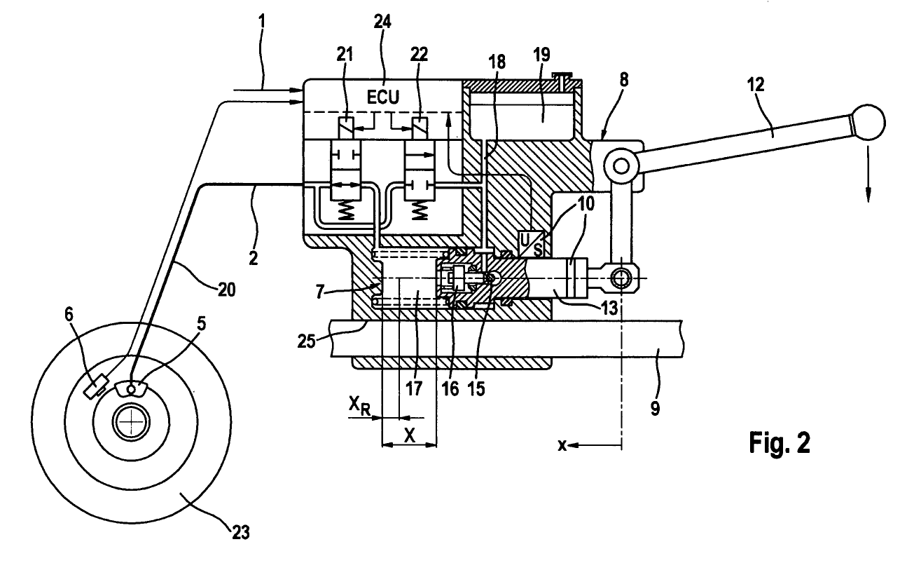

Although not shown in FIG. 1, the rear-wheel brake can be operated by way of a linkage or Bowden cable arranged between the brake pedal 11 and the wheel brake 14, as well as purely mechanically, in the simplest embodiment of the rear-wheel brake circuit 4, so that when viewing the front-wheel brake circuit 2 that will be explained in more detail by reference to FIG. 2, an especially straightforward motorcycle brake system with brake slip control is achieved, especially in connection with the rear-wheel brake circuit 4 that has an appropriately efficient design.

FIG. 2 shows the details of the motorcycle brake system at the hydraulically operable front-wheel brake circuit 2 which are required for brake slip control and integrated in the so-called front-wheel brake unit 8. The front-wheel brake unit 8 includes a manually operable master brake cylinder 7, a brake fluid supply tank 19 connected to the master brake cylinder 7, and each one electromagnetically operable inlet valve and outlet valve 21, 22 for brake slip control in the front-wheel brake circuit 2.

The brake pressure, which is manually produced in the brake line 20, can be limited by the inlet valve 21 at any time. The brake pressure reduction in the front-wheel brake 5 takes place by way of the outlet valve 22 directly into the supply tank 19, for what reason the outlet valve 22 is arranged in parallel to the inlet valve 21 between the front-wheel brake circuit 2 and the brake fluid supply tank 19 in a hydraulic connection.

Thus, FIG. 2 depicts in a favorable manner that the master brake cylinder 7 is structurally grouped with the supply tank 19, with the inlet and outlet valves 21, 22, and a travel sensor 10 to form an independently manageable, operable front-wheel brake unit 8, and the front-wheel brake unit 8 can be activated exclusively by means of a hand brake lever 12 that acts upon the master brake cylinder 7 for the purpose of slip-free brake operation as well as for pressure increase in a brake slip control action.

For the electric activation of the inlet and outlet valves 21, 22, a control device 24 is further provided, which is an integral component of the front-wheel brake unit 8. Preferably for the purpose of electrical contacting, the control device 24 is slipped onto the inlet and outlet valves 21, 22 and connected to the electrical wiring system 1 for power supply.

To attach the front-wheel brake unit 8 to a steering rod 9, the front-wheel brake unit includes a holding portion with a through-bore 25.

Hence, the invention provides that brake slip control is exclusively limited to the front-wheel brake 5 which regularly has to transmit high brake forces onto the roadway, and the pressure increase in the front-wheel brake circuit 2, being an essential element of the invention, is determined dependent on the switching position of the inlet and outlet valves 21, 22 by the brake fluid volume which is available in the master brake cylinder 7 and can be displaced exclusively manually into the front-wheel brake circuit 2.

To avoid exhaustion of the brake fluid volume during a brake slip control operation, as brake fluid can escape through the outlet valve 22 to the supply tank in the pressure reduction phase, provisions are made to monitor the brake fluid volume prevailing in the master brake cylinder 7.

In an expedient embodiment, the brake fluid volume in the master brake cylinder 7 is monitored by sensing the position of a working piston 13 in the master brake cylinder 7 that displaces the brake fluid into the front-wheel brake circuit 2, for what purpose the master brake cylinder 7 is equipped with the travel sensor 10.

If desired or required, the travel sensor 10 can be omitted when, based on the valve operation cycles, a so-called volume consumption model is reproduced for the slip-controlled front-wheel brake circuit 2 and stored as a performance graph in the control device 24. However, additional software is required with regard to this method in order to reach in good approximation the comparatively simple and precise volume consumption detection of the travel sensor 10. Hence, this alternative will not be referred to in detail herein and, rather, the significance of the travel sensor 10 will be pointed out in the following.

In order to evaluate the signals of the travel sensor 10, the electronic control device 24 is equipped with an appropriate evaluating circuit; and the control algorithms provided for the inlet and outlet valves 21, 22 will be modified, depending on the result of the evaluation of the signals of the travel sensor 10 by means of the control device 24, in such a fashion that the brake fluid volume in the master brake cylinder 7 can be dosed in a suitable manner during brake slip control and, thus, cannot be displaced prematurely through the inlet and outlet valves 21, 22 into the front-wheel brake circuit 2 or the supply tank 19, respectively. Favorably, this achieves a comfortable, only gradually rising actuating travel at the hand brake level 12, without the risk of premature exhaustion of the brake fluid volume in the master brake cylinder 7.

During the brake slip control operation, the brake fluid volume available in the master brake cylinder 7 can be reduced until a reserve volume required for the minimum braking deceleration of the motorcycle. When the reserve volume is reached, the travel sensor 10 causes the brake slip control at the front-wheel brake circuit 2 that is initiated by the control device 24 to be discontinued in that the inlet and outlet valves 21, 22 are no longer actuated electromagnetically. The inlet and outlet valves 21, 22 will then remain in their basic position, as shown, in which there is an unhindered pressure fluid connection to the front-wheel brake 5 through the inlet valve 21, however, escape of the pressure fluid out of the front-wheel brake circuit 2 into the supply tank 19 is prevented due to the closed position of the outlet valve 22.

In the embodiment at issue, pressure buildup takes place in the front-axle circuit 2 as soon as the central valve 16, which is kept mechanically open by means of a cylindrical pin 15 in the working piston 13, is closed after a short working piston stroke X due to actuation of the hand brake lever 12, with the result that the hydraulic connection of the supply reservoir 19 with the pressure chamber 17 in the master brake cylinder 7 is separated.

Alternatively, the central valve 16 can also be replaced by a sleeve-type valve at the working piston 13, which valve would override, and thereby isolate, a breathering bore connected to the supply tank 19 after a minimum working piston stroke X.

Apart from the types of valve constructions described hereinabove, the pressure chamber 17 of the master cylinder 7 is thus in any case separated from the supply tank 19 at the commencement of the actuation of the working piston 13. The wheel brake 5 is then connected hydraulically exclusively to the pressure chamber 17 of the master brake cylinder 7 by way of the brake line 20 and the normally open inlet valve 21. Manual pressure buildup in the front-wheel brake circuit 2 may thus take place.

Principally, the following applies:

1. An imminent locked condition of the front wheel 23 is reliably detected by means of the wheel rotational speed sensor 6 and its evaluation of signals in the control device 24. As mentioned hereinabove, the inlet valve 21 is electromagnetically closed by way of the control device 24 in order to stop further pressure buildup in the front-wheel circuit 2.

2. Should further pressure reduction in the front-wheel brake circuit 2 be additionally necessary to reduce the imminent locked condition, this aim is achieved by opening the normally closed outlet valve 22 that is connectable to the supply tank 19. The outlet valve 22 will be closed again as soon as the wheel acceleration rises beyond a defined value again. The inlet valve 21 remains closed in the pressure reduction phase so that the master cylinder pressure generated in the pressure chamber 17 by means of the hand brake lever 12 cannot propagate into the front-wheel brake circuit 2.

3. When the detected slip values allow pressure buildup in the front-wheel brake circuit 2 again, the inlet valve 21 will be opened within time limits in conformity with the demand of the slip controller integrated in the control device 24. The differential volume necessary for pressure buildup is now taken from the pressure chamber 17 of the master brake cylinder 13. As this occurs, the working piston stroke changes depending on the differential volume removed, i.e. the manually operated working piston 13 acts as a delivery pump for the front-wheel circuit 2 in the pressure increase phases.

As the brake fluid volume prevailing in the master brake cylinder 7 is limited, the initially explained modification of the control algorithms of the slip controller is used to minimize the volume consumption in the master brake cylinder 7 and, thus, the resulting working piston stroke X. The modification of the control algorithms allows dealing with the limited brake fluid volume in the pressure chamber 17 of the master brake cylinder 7 in a correspondingly economical fashion.

Since the travel sensor 10 is permanently detecting the position of the working piston 13, it is possible to calculate the volume being ‘consumed’ for the purpose of brake slip control at any time by means of the control device 24, and to disable the slip controller in a borderline case when a defined reserve stroke X_{R} is reached. The reserve volume then remaining in the pressure chamber 17 is chosen in such a way as to ensure full pressure buildup or the minimum deceleration by the front-wheel circuit (2) which is mandated by law for motorcycles.

Summarizing one can say that:

The brake system described is based on the integration of a low-cost ABS control system without a pump into the front-wheel brake circuit 2 of a motorcycle brake system, without taking influence on the rear-axle brake circuit 4 of conventional design.

The ABS control system is favorably integrated into a brake actuation unit of the front-wheel brake circuit 2 and forms a compact front-wheel brake unit 8. Optionally, the ABS control system can also be integrated as an independent construction unit into the front-wheel brake circuit 2.

This system is a so-called open-loop brake system because pressure reduction is carried out through the outlet valve directly into the supply tank 19, by way of which the pressure chamber 17 can be filled anew when the working piston 13 stays in the non-actuated basic position. For reasons of cost and integration, pressure is built up during brake slip control without using an electrically driven hydraulic pump, there being no need for a low-pressure accumulator due to the pressure reduction into the supply tank 19.

Finally, it should not be left unmentioned that, of course, the described features of the front-wheel brake circuit, with a corresponding additional effort, can be implemented on the rear-wheel brake circuit, or, respectively, the features of the front-wheel brake circuit can be added to the rear-wheel brake circuit, if this is desired or required.

### LIST OF REFERENCE NUMERALS

1 electrical wiring system
2 front-wheel brake circuit
3 master brake cylinder
4 rear-wheel brake circuit
5 wheel brake
6 rotational speed sensor
7 master brake cylinder
8 front-wheel brake unit
9 steering rod
10 travel sensor
11 brake pedal
12 hand brake lever
13 working piston
14 wheel brake
15 cylindrical pin
16 central valve
17 pressure chamber
18 return line
19 supply tank
20 brake line
21 inlet valve
22 outlet valve
23 front wheel
24 control device
25 through-bore

1-9. (canceled)

10. A motorcycle brake system comprising:
one hydraulically operable front-wheel brake circuit;
a manually operable master brake cylinder connected to the front-wheel brake circuit and in communication with a brake fluid supply tank; and
at least one inlet valve and outlet valve that can be activated for brake slip control in the front-wheel brake circuit, wherein in a brake slip control operation, a pressure buildup in the front-wheel brake circuit (2) is determined, depending on a switching position of the inlet and outlet valves (21,22), by a brake fluid volume which is available in the master brake cylinder (7) and displaceable exclusively manually into the front-wheel brake circuit (2), and the brake fluid volume prevailing in the master brake cylinder (7) is monitored to prevent exhaustion of the brake fluid volume.

11. A motor cycle brake system according to claim 10, wherein a travel sensor (10) is provided in the master brake cylinder to sense a position of a working piston, that displaces the brake fluid into the front-wheel brake circuit, in the master brake cylinder to monitor the brake fluid volume prevailing in the master brake cylinder.

12. A motor cycle brake system according to claim 11, wherein in order to evaluate signals of the travel sensor (10), an evaluating circuit includes an electronic control device (24) in which, depending on a result of evaluation, modification of control algorithms intended for the inlet and outlet valves (21, 22) can be performed in such a manner that, with the decrease of brake fluid volume in the master brake cylinder (7), the volume consumption in the master brake cylinder (7) is minimized by appropriate switching of the inlet and outlet valves (21, 22).

13. A motor cycle brake system according to claim 12, wherein the brake fluid volume available in the master brake cylinder (7) can be reduced during brake slip control to a reserve volume that is needed for the minimum braking deceleration, and in that the brake slip control for the front-wheel brake circuit (2) initiated by the control device (24) is discontinued when the reserve volume is reached.

14. A motor cycle brake system according to claim 11, wherein the master brake cylinder (7) is structurally grouped with the supply tank (19), the travel sensor (10) and the inlet and outlet valves (21, 22) to form an independently manageable, operable front-wheel brake unit (8), and for pressure buildup in a brake slip control operation, the front-wheel brake unit (8) can be operated exclusively by means of a hand brake lever (12) or brake pedal that acts on the master brake cylinder (7).

15. A motor cycle brake system according to claim 10, wherein a rear-wheel brake circuit (4) operable independently of the front-wheel brake circuit (2) is provided, which can be operated mechanically and/or hydraulically, wherein there is a direct force-proportional mechanical and/or hydraulic connection between a manually operable brake lever or brake pedal (11) and a wheel brake (14) of the rear-wheel brake circuit (4).

16. A motor cycle brake system according to claim 10, wherein the inlet valve (21) is arranged for brake pressure buildup in a hydraulic connection between the master brake cylinder (7) and the front-wheel brake circuit (2), and in that the outlet valve (22) is provided for brake pressure reduction into the supply tank (19) in a parallel connection to the inlet valve (21) between the front-wheel brake circuit (2) and the brake fluid supply tank (19).

17. A motor cycle brake system according to claim 10, wherein the control device (24) forms an integral component of the front-wheel brake unit (8) which is preferably slipped onto the inlet and outlet valves (21, 22) for electrical contacting.

18. A motor cycle brake system according to claim 10, wherein the front-wheel brake unit (8) includes a holding portion with a through-bore (25) for attachment at a steering rod (25) or at a motorcycle frame (26).
